(19) United States
(12) Patent Application Publication
(10) Pub. No.: US 2026/0287461 A1
(43) Pub. Date: Sep. 24, 2026

(54) Plumbing Leak Containment, Indicator, & Detection Device and Method for Detecting a Plumbing System Leak & Preventing Structural Damage

(71) Applicant: Yoram Mimun, Yorba Linda, CA (US)

(72) Inventor: Yoram Mimun, Yorba Linda, CA (US)

(21) Appl. No.: 19/091,631

(22) Filed: Mar. 26, 2025

(30) Foreign Application Priority Data
Mar. 26, 2024 (US) 63/569860

(51) Int. Cl. G01M 3/22

(52) U.S. Cl. CPC G01M 3/22

(57) ABSTRACT

A leak detection and containment system device and method for plumbing components, fixtures and systems, incorporating a polymer container, impermeable to liquid, a dye package for visible leak indication and detection, and an outlet to a safe collection or dispersal zone. This system provides an innovative solution for early detection of plumbing leaks and failures, preventing extensive property damage and the health risks associated with mold and other biotic growth from long term unseen leaks and plumbing failures.

### CROSS-REFERENCE TO RELATED APPLICATIONS

This application claims the benefit of U.S. Provisional Patent Application No. 63/569,860, filed on Mar. 26, 2024, the disclosure of which is incorporated herein by reference in its entirety.

### I. BACKGROUND OF THE INVENTION

The invention relates to plumbing parts, plumbing fixtures, and plumbing systems, and the prevention of damage associated with the failure of these systems, fixtures, component parts, and the structures that contain them.

### I. Field of the Invention

This invention pertains to the field of plumbing, specifically addressing the containment, indication, and detection of leaks in plumbing systems to mitigate damage and health risks in residential, office, and human habitation environments.

### II. State of the Art

The current state of the art for plumbing leak containment, indication, and detection, particularly in residential, office, and environments designed for human use or habitation, includes a plastic containment box designed to house plumbing cartridge fixtures. However, these boxes are not sealed at juncture points to be impermeable to liquid and are open on one face, thereby failing to prevent liquid leakage and associated damage and health risks. Additionally, they lack any indicator to alert users of a plumbing system failure behind an enclosed wall.

Another state-of-the-art solution is a plastic shielding box intended to house plumbing cartridge fixtures and protect the cartridge valve and adjoining pipes from physical impact. This design prioritizes physical protection rather than safeguarding the wall interior from water damage due to leaks.

A further state-of-the-art approach for containing plumbing pipe leaks involves a double-walled pipe, primarily used in industrial environments. The outer wall of the double-walled pipe contains liquid or gas from the inner pipe, thereby preventing or minimizing leakage and associated damage. However, this prior art does not address leakage from system components and valves and lacks an indicator for system failure.

Another known technique in the art employs various chemical and physical dyes to alert a human or electronic observer of system failure. These methods vary in application but are commonly used to signal leaks in specific contexts.

The Applicant is aware of several plumbing leak containment, indication, and detection inventions related to the present invention, as documented in U.S. and foreign patents. These include:
Water leak disclosing agent and water leak detection method, Hsu, 2008 Jul., 10, Assignee N/A, US20080163706A1
Leak detection method using microencapsulated dye precursor, Zyhowski et al., 2005 Feb. 24, Assignee N/A, US20050042758A1 Refrigerant with leak detection dye concentrate, Duerr et al., 2007 Aug. 7, Spectronics CORPORATION, U.S. Pat. No. 7,251984B2
Method for detecting leakage in a refrigeration system, Parekh, 1992 Sep. 22, H. B. Fuller Automotive Products, Inc., U.S. Pat. No. 5,149,453A
Leak detection additives for use in heating, ventilating, refrigeration, and air conditioning systems, Cavestri, 2000 Jun. 6, Bright Solutions Inc., U.S. Pat. No. 6,070,454A
Leak detection dye delivery system, Kalley et al., 2001 Feb. 6, Bright Solutions Inc., U.S. Pat. No. 6,183,663B1
Device and method for detection/indication of liquid leakage, Tom et al., 2007 May 8, TB Invent AB, U.S. Pat. No. 7,213,534B2
End of life indicator for automatic toilet cleaning devices, Sinclair et al., 1989 Jan. 24, The Drackett Company, U.S. Pat. No. 4,800,066A
Method for detecting leaks in structures, Duerr, 2004 Jun. 24, Assignee N/A, US20040118185A1
Polyhalogenated hydrocarbon refrigerants and refrigerant oils colored with fluorescent dyes and method for their use as leak detectors, Parekh, 1988 Jul. 19, Assignee N/A, U.S. Pat. No. 4,7583,66A
Moisture/wetness detecting method, moisture/wetness detecting label, articles with moisture/wetness detecting function, and detecting material and method, Yabuki et al., 2002 May 23, Assignee N/A, US20020061595A1
Hybrid fluorescent UV dye for refrigerant systems, Khizar et al., 2023 Aug. 15, Assignee

### N/A, US11726000B2

Viewing the aforementioned known inventions individually and as a whole, there is no suggestion of a configuration that approximates the current invention. A need persists for a plumbing system leak containment, indication, and detection device, and a method for detecting a plumbing system leak that enables a user to contain a plumbing system failure, identify that a failure has occurred within the containment area, release liquid pressure within the containment area, divert fluid into a safe area, be alerted by an indicator, and minimize property and health risks associated with short-and long-term undetected system failure. This need is particularly acute, though not exclusively, within bath and shower environments and with the failure of controllers, valves, and pipes in these settings, as addressed by the present invention and its various iterations.

While several cited inventions present plumbing leak containment, indicators, and detection alert features in various forms, they lack an integrated plumbing system leak containment, indication, and detection system as presented in the current invention.

Dyes, dye packets, and a variety of physical indicators are employed in the art for leak detection across different applications. However, there is no known precedent for their use in a sealable containment, indicator, outlet, and detection device as proposed herein.

The present invention offers a superlative and elegant solution to the long-standing, unresolved problem of plumbing system failure. It achieves this by containing liquid from plumbing system failure within the device, directing liquid to a safe location, and alerting users of failure in a timely manner to minimize damages and costs. This solution is particularly applicable to residential and office environments, as well as any plumbing system environment where the possibility of system failure exists.

### II. SUMMARY OF THE INVENTION

The invention comprises a Plumbing System Leak Containment, Indicator, & Detection Device (the “Device”) and a Method for Detecting a Plumbing System Leak (the “Method”). It addresses the need for an efficient, non-invasive leak detection system within plumbing walls.

The Device may be configured with a polymer container forming a watertight zone around plumbing fixtures, a dye package that releases pigment upon contact with water to provide a visible alert, and a mechanism to direct liquid to a safe zone. It may be installed within a wall cavity adjacent to shower and tub fixtures. In the event of a plumbing system leak, water enters the polymer container, activates the dye package, and the resulting pigmented water drains through an exit hole into a shower or tub area, visibly indicating the leak.

The Device prevents liquid leakage into plumbing walls or surrounding areas, thereby minimizing or eliminating damage from liquid exposure and associated environmental risks. It may be constructed from a durable, flexible, or rigid polymer, or any material capable of containing water and withstanding environmental conditions within a plumbing wall. The dye package may contain an easily visible pigment, preferably non-toxic and safe for human exposure in residential or office environments.

Undetected plumbing system leaks can cause significant damage to building structures, with repair costs far exceeding those of fixing the plumbing system itself. The Device aims to prevent such damage by containing leaks within the installed system, directing water to an intended safe area, and alerting an observer to the presence of a leak.

### III. BRIEF DESCRIPTION OF THE DRAWINGS

The accompanying figures illustrate the best mode currently contemplated for the present invention. These figures, in which like reference numerals refer to identical or functionally similar elements throughout the separate views, are incorporated into and form part of the specification. Together with the Detailed Description of the Invention, they serve to explain the principles of the invention.

FIG. 1 illustrates an exemplary embodiment of a Plumbing System Leak Containment, Indicator, & Detection Device, shown generally at 10. The device includes a Plumbing System Containment Area 10 comprising a Polymer Liquid Containment Material 100, Watertight Joint Seals 200 to prevent liquid escape at joints, a Leak Indicator 300, and a Leak Indicator Outlet 400. The system is configured to encase a plumbing assembly of one or more Pipes 500, or Pipes 500 combined with one or more Rough-In Plumbing Valves 600.

FIG. 2 depicts a configuration of the Plumbing System Leak Containment, Indicator, & Detection Device with a Plumbing System Containment Area shown generally at 20. It features a Polymer Liquid Containment Material 100, Watertight Joint Seals 200, a Leak Indicator Material 300, and a Leak Indicator Spill Outlet 400 passing through a Waterproof Wall or Shower Wall 800, where a Valve Control Arm 610 extends through the wall, directing liquid to an observable area, preferably with a drain. The device surrounds Pipes 500 and a Rough-In Plumbing Valve 600, secured to Wall Frame Members 900 on a Floor or Sub-Floor 1000, with the valve mounted to a Wall Frame Mounting Member 910.

FIG. 3 shows a localized configuration of the Plumbing System Leak Containment, Indicator, & Detection Device, shown generally at 30, around a Rough-In Plumbing Valve 600, viewed from the front. It includes a Valve Containment Box (the “Box”) 150, into which Pipes 500 enter, sealed with Watertight Pipe Seals 210. The Box 150 is mounted using fasteners through Watertight Mounting Fastener Gaskets 230, with its front perimeter sealed by a Watertight Seal and Liquid Diverter Gasket 220, to divert liquid to a Leak Indicator Spill Outlet 400.

FIG. 4 represents a side view of the Plumbing System Leak Containment, Indicator, & Detection Device within a Plumbing System Containment Area, shown generally 40. A Valve Containment Box (the “Box”) 150, made of Polymer Liquid Containment Material 100, is mounted to a Wall Frame Mounting Member 910. Pipes 500 enter through Watertight Pipe Seals 210, connecting to a Rough-In Plumbing Valve 600. Leak Indicator Material 300 within the Box 150 mixes with liquid from a failure, exiting via a Leak Indicator Spill Outlet 400 through a Watertight Seal and Liquid Diverter Gasket 220 and Waterproof Wall or Shower Wall 800, alerting observers with pigmented liquid.

FIG. 5 illustrates a front view of the Plumbing System Leak Containment, Indicator, & Detection Device within a Plumbing System Containment Area, shown generally at 50, set in a wall with Wall Frame Members 900 on a Floor or Sub-Floor 1000. A Polymer Liquid Containment Material 100 encloses a Rough-In Plumbing Valve 600 and sections of Pipes 500, within a Valve Containment Box (the “Box”) 150, sealed with Watertight Joint Seals 200 & 210. Leak Indicator Material 300 inside the Valve Containment Box 150 mixes with liquid released from a plumbing failure within the containment system, and exiting at a Leak Indicator Spill Outlet 400.

FIG. 6 depicts a side view of the Plumbing System Containment Area, shown generally at 60, within a wall frame structure, supporting a Waterproof Wall or Shower Wall 800. A Rough-In Plumbing Valve 600, mounted to a Wall Frame Mounting Member 910, through Watertight Mounting Fastener Gaskets 230, is enclosed in a Valve Containment Box (the “Box”) 150, with Pipes 500 sealed by Watertight Joint Seals 200 and 210, within Polymer Liquid Containment Material 100. A Watertight Seal and Liquid Diverter Gasket 220 channels liquid from the Box 150 to a Leak Indicator Spill Outlet 400 through the wall, alongside a Valve Control Arm 610.

FIG. 7 outlines a sequential method for detecting a plumbing system leak using the device: Step 1: Encase the selected plumbing system area. Step 2: Place a colored indicator mechanism within the encased area. Step 3: Seal open regions of the encased area. Step 4: Direct liquid outflow from a failure to a spill area, interacting with pigmented indicator material. Step 5: Observe pigmented liquid outflow to identify failure. Step 6: Turn off water flow for repair. Step 7: Repair or replace failed parts. Step 8: Restore water flow and return to Step 1.

### IV. DETAILED DESCRIPTION OF THE INVENTION

The particular values and configurations discussed in these non-limiting examples incorporate the accompanying descriptions and figures cited above. They can be varied and are cited merely to illustrate an embodiment of the present invention, not to limit its scope.

The invention addresses the need for an efficient, non-invasive leak detection system within plumbing walls. It comprises a polymer container that forms a watertight zone around plumbing fixtures and a dye package that releases pigment upon contact with water, providing a visible alert. The device may be installed within a wall cavity adjacent to shower and tub fixtures. In the event of a leak, water enters the polymer container, activates the dye package, and the resulting pigmented water drains through a shower wall into a shower or tub area, serving as a visible indication of the leak. The device is constructed from one or more flexible or rigid durable polymers designed to withstand environmental conditions within a plumbing wall. The dye package contains a non-toxic, easily visible pigment safe for human exposure. It should be appreciated that a scent packet could substitute for or complement the dye package for enhanced user notification.

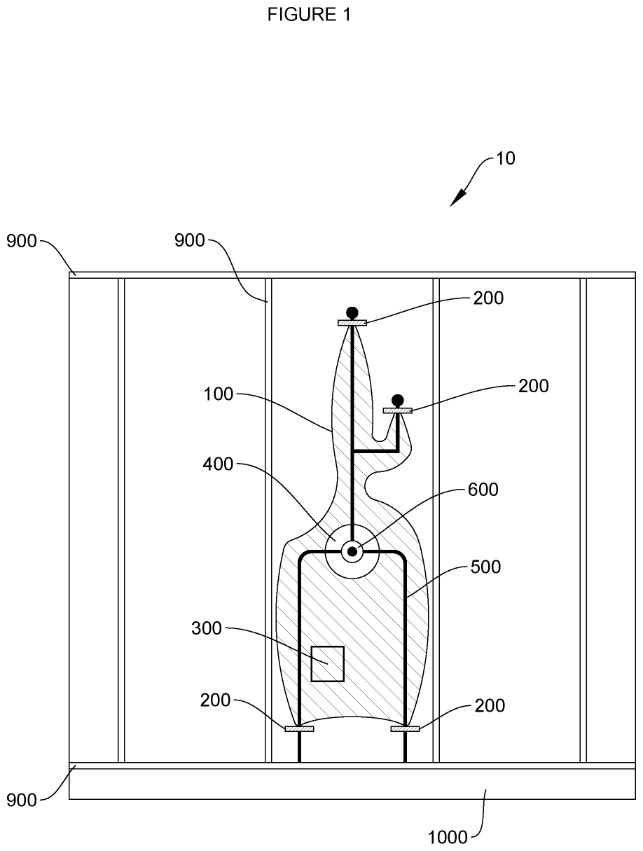

Referring to FIG. 1, the invention provides an exemplary embodiment of a Plumbing System Leak Containment, Indicator, & Detection Device, shown generally at 10. The device includes a Plumbing System Containment Area 10 comprising a Polymer Liquid Containment Material 100, Watertight Joint Seals 200 to prevent liquid escape at joints, a Leak Indicator 300, and a Leak Indicator Outlet 400. The system is configured to encase a plumbing assembly of one or more Pipes 500, or Pipes 500 combined with one or more Rough-In Plumbing Valves 600.

It should be appreciated that alternative configurations may utilize some or all of these elements, or additional components. Although depicted as a residential shower device, the device may be adapted for industrial environments or any setting requiring leak containment, indication, and detection, such as roof leak containment, swimming pool leak containment, pond leak containment, shipping container leak containment, beverage packaging leak containment, petroleum product leak containment, or boat leak containment devices. The applications are virtually unlimited. The current configuration may be altered partially or wholly to incorporate some or all components, or additional elements, to achieve similar yet alternative leak containment, indication, and detection devices.

It should further be appreciated that the colored indicator material may be supplemented or replaced by other indicator mechanisms, including electronic signals, sounds, odors, or other human-observable or technically observable indicators (e.g., via tools, sensors, or displays). The colored indicator material or similar components may be replaceable for repeated use of the device following water containment, alert activation, and diversion.

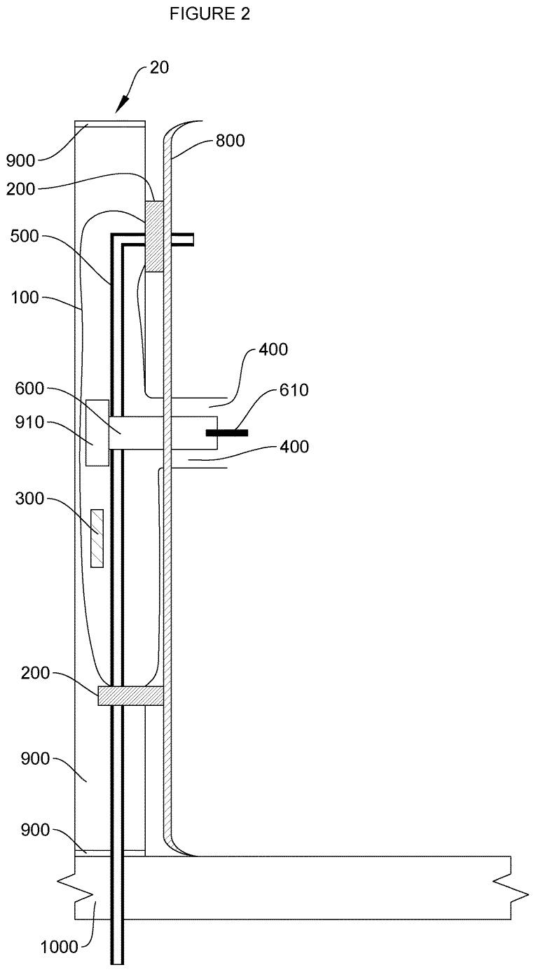

Referring to FIG. 2, the Plumbing System Leak Containment, Indicator, & Detection Device includes a Plumbing System Containment Area, shown generally at 20, with a Polymer Liquid Containment Material 100, Watertight Joint Seals 200, a Leak Indicator Material 300, and a Leak Indicator Spill Outlet 400 passing through a Waterproof Wall or Shower Wall 800. A Valve Control Arm 610 extends through the wall, directing liquid to an observable area, preferably with a drain. The device surrounds Pipes 500 and a Rough-In Plumbing Valve 600, secured to Wall Frame Members 900 on a Floor or Sub-Floor 1000, with the valve mounted to a Wall Frame Mounting Member 910. The Polymer Liquid Containment Material 100 directs liquid to the Leak Indicator Spill Outlet 400, maintaining a dry zone outside the device within the wall cavity. A Watertight Seal and Liquid Diverter Gasket 220 may attach directly to a Rough-In Plumbing Valve 600, Pipe 500, or other device features.

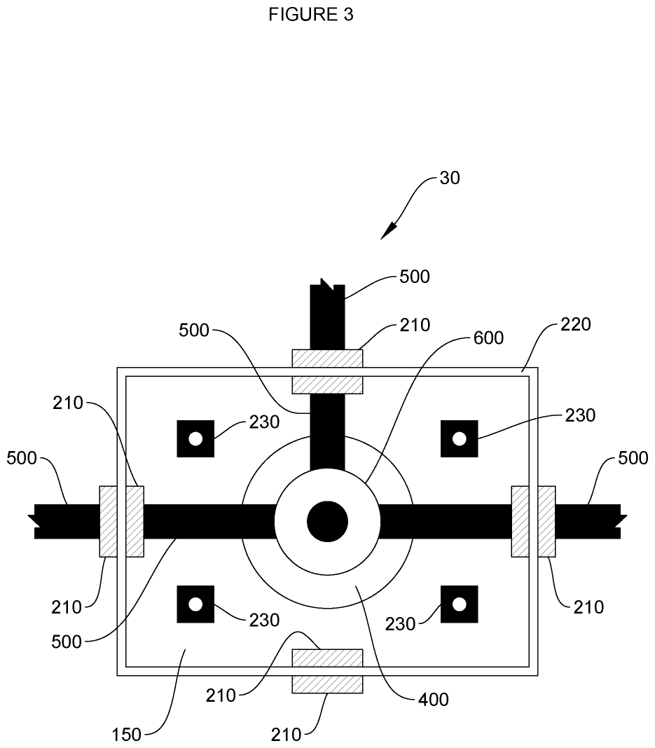

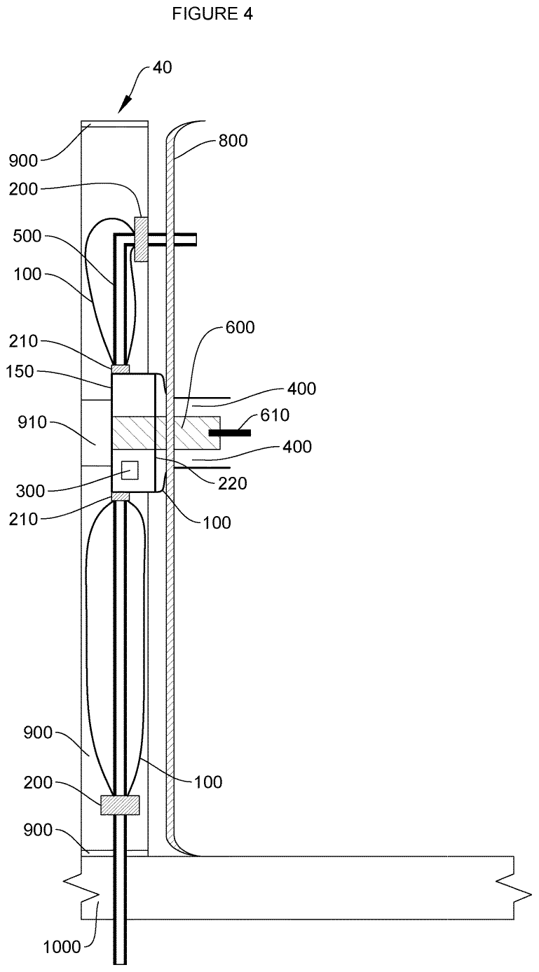

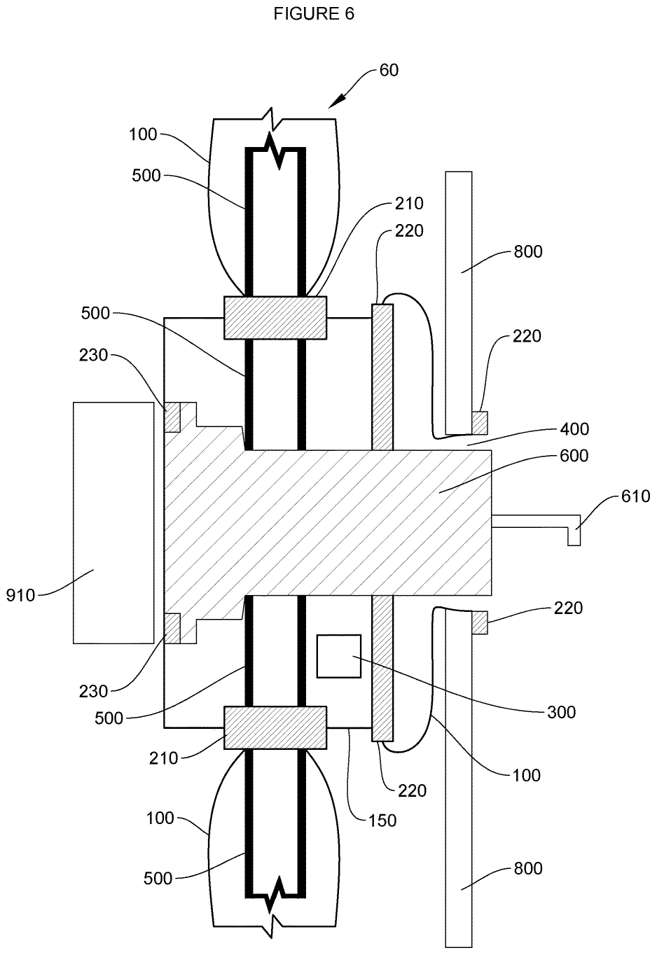

Referring to FIG. 3, the device is localized to a Rough-In Plumbing Valve 600 area, featuring a Valve Containment Box (the “Box”) 150, viewed from the front, shown generally 30. Pipes 500 enter the Box 150, sealed with Watertight Pipe Seals 210 to prevent liquid escape during a plumbing failure. The Box 150 is mounted with fasteners through Watertight Mounting Fastener Gaskets 230, and its front perimeter is sealed by a Watertight Seal and Liquid Diverter Gasket 220. This gasket extends from the Box 150 through a Waterproof Wall or Shower Wall 800 (as shown in FIGS. 4 and 6), channeling liquid to a Leak Indicator Spill Outlet 400, forming a watertight path around the Rough-In Plumbing Valve 600 to a target area like a bathtub or shower pan. Additional elements or equivalent materials may be integrated to enhance leak containment, indication, and detection.

Referring to FIG. 4, a side view of the Plumbing System Containment Area, shown generally at 40, shows a Valve Containment Box (the “Box”) 150 made of Polymer Liquid Containment Material 100, mounted to a Wall Frame Mounting Member 910. Pipes 500 enter through Watertight Pipe Seals 210, connecting to a Rough-In Plumbing Valve 600. The Box 150 houses Leak Indicator Material 300, which mixes with liquid from a failure, exiting via a Leak Indicator Spill Outlet 400 through a Watertight Seal and Liquid Diverter Gasket 220 and Waterproof Wall or Shower Wall 800, producing a pigmented spill to alert observers. The Box 150 is secured with fasteners through Watertight Mounting Fastener Gaskets 230. Equivalent materials and components may be alternatively integrated to achieve the same function.

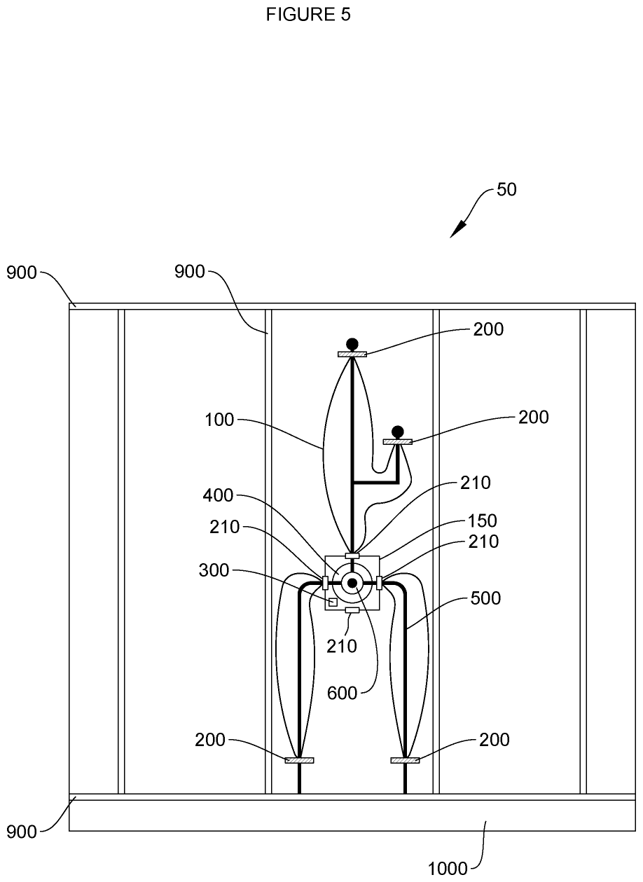

Referring to FIG. 5, a front view of the Plumbing System Containment Area, shown generally at 50, within a wall with Wall Frame Members 900 on a Floor or Sub-Floor 1000 shows a Polymer Liquid Containment Material 100 enclosing Pipes 500, sealed with Watertight Joint Seals 200, channeling liquid into a Valve Containment Box (the “Box”) 150. The Valve Containment Box 150 is housing a Rough-In Plumbing Valve 600, sealed with Watertight Pipe Seals 210, Leak Indicator Material 300 mixes with liquid from a plumbing system failure, with indicator liquid exiting at a Leak Indicator Spill Outlet 400. The device may be adapted for various environments beyond residential showers, such as industrial or other leak-prone settings. The Box 150 and Polymer Liquid Containment Material 100 may be integrated or deployed independently.

Referring to FIG. 6, a side view of the Plumbing System Containment Area, shown generally at 60, within a wall frame structure (Wall Frame Members 900 on a Floor or Sub-Floor 1000, with a Waterproof Wall or Shower Wall 800) shows a Rough-In Plumbing Valve 600 mounted to a Wall Frame Mounting Member 910, enclosed in a Valve Containment Box (the “Box”) 150. A watertight seal 200 seals off the Polymer Liquid Containment Material 100 around the outer perimeter of the circumference of the Pipe 500, at a point or points along a length of the Pipe 500, within the Containment Area. A containment areas is surrounded by a Polymer Containment Liquid Containment Material Pipes 500 are sealed within Polymer Liquid Containment Material 100 using Watertight Joint Seals 200. A Watertight Seal and Liquid Diverter Gasket 220 connects the Box 150 to a Leak Indicator Spill Outlet 400 through the wall, channeling liquid to a safe zone alongside a Valve Control Arm 610. Equivalent materials and components may be used to achieve the intended function.

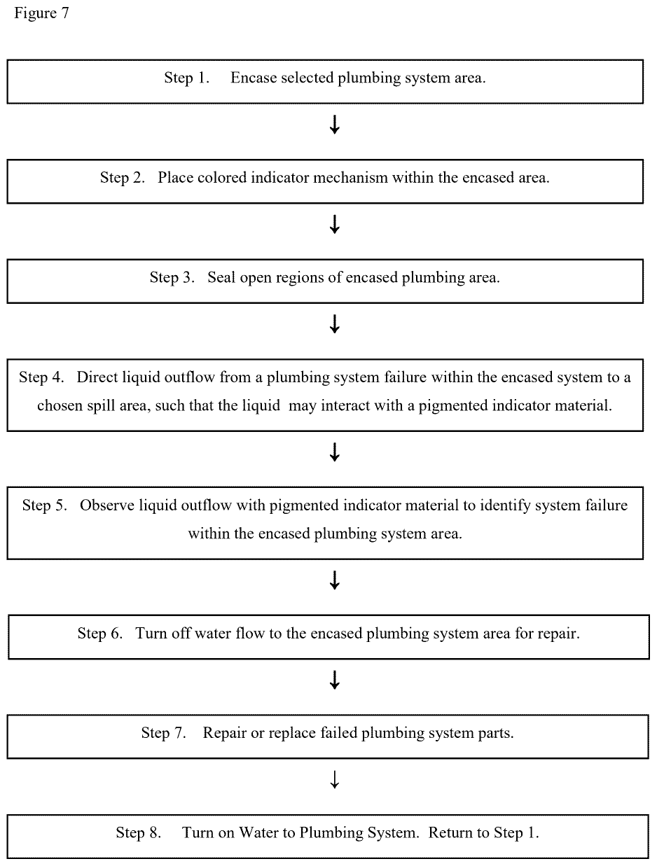

Referring to FIG. 7, a sequential method for detecting a plumbing system leak is illustrated: Step 1: Encase the selected plumbing system area. Step 2: Place a colored indicator mechanism within the encased area. Step 3: Seal open regions of the encased area. Step 4: Direct liquid outflow from a failure to a spill area, interacting with pigmented indicator material. Step 5: Observe pigmented liquid outflow to identify failure. Step 6: Turn off water flow for repair. Step 7: Repair or replace failed parts. Step 8: Restore water flow and return to Step 1. This method may be altered by modifying steps or adding additional steps to achieve a similar result.

In conclusion, the Plumbing System Leak Containment, Indicator, & Detection Device and Method for Detecting a Plumbing System Leak described herein demonstrate a novel approach to plumbing leak containment, indication, and detection. The embodiments and examples are presented to explain the invention and its practical application, enabling those skilled in the art to make and utilize it. These descriptions are illustrative, not exhaustive, and numerous variations and modifications are possible without departing from the spirit and scope of the invention. It is intended that such variations and modifications be covered, with the scope defined by the claims, giving full cognizance to equivalents in all respects.

The inventor claims:

1. A plumbing leak containment, indication, and detection device comprising:
a watertight polymer container, configured to encase a plumbing fixture within a wall cavity, the plumbing fixture comprising at least one of a pipe or a valve;
a dye package disposed within the watertight polymer container, the dye package configured to release a visible pigment upon contact with water from a leak in the plumbing fixture; and
a leak indicator spill outlet coupled to the watertight polymer container, the leak indicator spill outlet configured to direct the pigmented water from the watertight polymer container to an observable area outside the wall cavity,
wherein the device is configured to contain the leak, indicate the leak via the visible pigment, and divert the pigmented water to the observable area to prevent damage to the wall cavity.

2. The device of claim 1, wherein the plumbing fixture is a rough-in plumbing valve installed in a shower or tub environment, and the observable area is a shower pan or tub basin.

3. The device of claim 1, wherein the watertight polymer container comprises a valve containment box and a polymer liquid containment material, the valve containment box being sealed with watertight joint seals to prevent liquid escape.

4. The device of claim 1, wherein the dye package contains a non-toxic pigment safe for human exposure in a residential environment.

5. The device of claim 1, further comprising a watertight seal and liquid diverter gasket coupled to the leak indicator spill outlet, the gasket configured to channel the pigmented water through a waterproof wall into the observable area.

6. The device of claim 1, wherein the watertight polymer container is constructed from a durable polymer material configured to withstand environmental conditions within the wall cavity.

7. The device of claim 1, wherein the watertight polymer container is mounted to a wall frame member within the wall cavity using fasteners, the fasteners being sealed with watertight mounting fastener gaskets to prevent liquid escape.

8. The device of claim 1, wherein the dye package is configured to release the visible pigment in a concentration sufficient to be visible in the observable area under ambient lighting conditions.

9. The device of claim 1, wherein the leak indicator spill outlet is positioned to direct the pigmented water to a drainage area within the observable area, the drainage area being configured to safely dispose of the pigmented water.

10. The device of claim 1, wherein the watertight polymer container is flexible to accommodate variations in the size or shape of the plumbing fixture.

11. A method for detecting a plumbing system leak, the method comprising:
encasing a plumbing fixture within a wall cavity with a watertight polymer container, the plumbing fixture comprising at least one of a pipe or a valve;
placing a dye package within the watertight polymer container, the dye package configured to release a visible pigment upon contact with water;
sealing the watertight polymer container to prevent liquid escape;
directing, via a leak indicator spill outlet, pigmented water from a leak in the plumbing fixture to an observable area outside the wall cavity; and
observing the pigmented water in the observable area to identify the leak, wherein the method contains the leak, indicates the leak via the visible pigment, and diverts the pigmented water to the observable area to prevent damage to the wall cavity.

12. The method of claim 11, wherein the plumbing fixture is a rough-in plumbing valve in a shower or tub environment, and the observable area is a shower pan or tub basin.

13. The method of claim 11, further comprising:
turning off water flow to the plumbing fixture upon observing the pigmented water;
repairing or replacing the plumbing fixture; and
resuming water flow to the plumbing fixture after repair.

14. The method of claim 11, wherein sealing the watertight polymer container comprises using watertight joint seals and a watertight seal and liquid diverter gasket to prevent liquid escape inside a plumbing wall.

15. The method of claim 11, wherein the dye package releases a pigment that contrasts with a color of the observable area to enhance visibility of the leak.

16. The method of claim 11, further comprising installing the watertight polymer container adjacent to a waterproof wall, wherein the leak indicator spill outlet passes through the waterproof wall to direct the pigmented water to the observable area.

17. A leak containment and detection device for a plumbing system, comprising:
a sealed container configured to encase a portion of the plumbing system within a wall cavity, the sealed container being impermeable to liquid;
an indicator mechanism disposed within the sealed container, the indicator mechanism configured to provide a human-observable signal upon contact with water from a leak in the plumbing system; and
an outlet coupled to the sealed container, the outlet configured to direct water from the leak to an observable area outside the wall cavity,
wherein the device is configured to contain the leak within the sealed container, provide the human-observable signal to indicate the leak, and divert the water to the observable area to prevent damage to the wall cavity.

18. The device of claim 17, wherein the indicator mechanism comprises a dye package configured to release a visible pigment upon contact with water, the visible pigment being carried by the water through the outlet to the observable area.

19. The device of claim 17, wherein the indicator mechanism comprises an electronic sensor configured to emit at least one of a sound, light, or electronic signal upon contact with water.

20. The device of claim 17, wherein the sealed container is configured to encase a rough-in plumbing valve in a shower or tub environment, and the observable area is a shower pan or tub basin.
